(19) United States
(12) Patent Application Publication
(10) Pub. No.: US 2016/0132918 A1
(43) Pub. Date: May 12, 2016

(54) ONE-TAP SIGN UP FOR MERCHANT LOYALTY PROGRAMS

(71) Applicant: Neil Richard Thomas, Waterloo (CA)

(72) Inventor: Neil Richard Thomas, Waterloo (CA)

(73) Assignee: GOOGLE Inc., Mountain View, CA (US)

(21) Appl. No.: 13/410,209

(22) Filed: Mar. 1, 2012

(51) Int. Cl. G06Q 30/02; H04W 4/00

(52) U.S. Cl. CPC G06Q 30/0226; H04W 4/008; G06Q 30/0238

(57) ABSTRACT

Automatic processing and registering for merchant loyalty reward programs initiated by a single tap of a contactless device to a terminal reader. A user taps the contactless device in the terminal reader's radio frequency field. The terminal reader and the contactless device establish a communication channel and the terminal reader transmits details of the merchant's loyalty rewards program and a request for user information. The contactless device receives the request and accesses the user's stored information. The contactless device transmits the user information to the terminal reader and a new merchant loyalty account is created for the user. Acknowledgement of the new account, including a new loyalty account number, is transmitted to the contactless device. The loyalty account number is then saved in the contactless device.

### TECHNICAL FIELD

The present disclosure relates generally to contactless devices, and more particularly to methods and systems that allow automatic processing and registering for merchant loyalty reward programs initiated by a single tap of a contactless device.

### BACKGROUND

Near Field Communication (“NFC”) is a proximity communication technology that can enable contactless device payment technologies and that is supported by the Global System for Mobile Communications (“GSM”) Association. Radio frequency identification (“RFID”) is another wireless communication technology that can be adapted to enable NFC contactless device payment technology. NFC communication generally is conducted in a range from about 3 to about 4 inches. Such short communication distances enable secure communication between close field proximity enabled devices. In operation of an NFC transaction, a user “taps” a contactless device, such as an NFC-enabled mobile phone, to a reader of a point of sale system. The reader recognizes the NFC-enabled device when the device is moved within range of the reader, establishes a secure communication channel with the device, and initiates an exchange between the reader and the device. The duration of the transaction is very short and does not easily permit communication of other information or conducting of other services during the transaction. Additionally, the device must be held close to the reader during the entire NFC transaction.

In GSM phones, a proximity-enabled controller (for example, an NFC controller) with an antenna is incorporated into the contactless device with the secure contactless software applications located on a smart chip. NFC contactless devices can function as a credit card to enable purchases at the point-of-sale. NFC contactless devices can also function to transmit preselected data to another NFC contactless device or a reader device. However, the short duration of conventional methods and systems for contactless devices do not enable the utilization of value-added services, user choices, or registration for programs based on the information transmitted. During the conventional transaction, the contactless device and the reader (or second contactless device) communicate to complete a predefined transaction. Further user input or further transactions, such as user selection of contact data to be transmitted, exchange of terms of use, processing of user data to register for a merchant loyalty program, or automatic application of those items, is not possible in the predefined NFC transaction. Alternative conventional methods require multiple taps or a tap and hold of the contactless device to enable the utilization of each service, resulting in user inconvenience.

### SUMMARY

In certain exemplary aspects, systems and methods of automatic processing and registering for merchant loyalty reward programs initiated by a single tap comprises a terminal reader that facilitates a communication channel with a contactless device. A user taps the contactless device in the terminal reader's radio frequency field. The terminal reader and the contactless device establish a communication channel and the terminal reader transmits details of the merchant's loyalty rewards program and a request for user information. The contactless device receives the request and accesses the user's information resident in the contactless device. The contactless device transmits the user information to the terminal reader and a new merchant loyalty account is created for the user. Acknowledgement of the new account, including a new loyalty account number, is transmitted to the contactless device. The loyalty account number is then saved in the contactless device.

These and other aspects, objects, features and advantages of the exemplary embodiments will become apparent to those having ordinary skill in the art upon consideration of the following detailed description of illustrated exemplary embodiments, which include the best mode of carrying out the invention as presently presented.

### BRIEF DESCRIPTION OF THE DRAWINGS

FIG. 1 is a block diagram depicting a system for a one-tap sign up for merchant loyalty programs according to an exemplary embodiment.

FIG. 2 is a block flow diagram depicting a method for registering for merchant loyalty programs according to an exemplary embodiment.

FIG. 3 is a block flow diagram depicting a method for sharing user information according to an exemplary embodiment.

FIG. 4 is a block flow diagram depicting a method for reading user information according to an exemplary embodiment.

FIG. 5 is a block flow diagram depicting a method for requesting user information according to an exemplary embodiment.

FIG. 6 is a block flow diagram depicting a method for creating a new loyalty program account according to an exemplary embodiment.

### DETAILED DESCRIPTION OF EXEMPLARY EMBODIMENTS

### Overview

The exemplary embodiments provide methods and systems that enable users to register for merchant loyalty reward programs with a single tap of a contactless device. A user taps the contactless device in the terminal reader's radio frequency field. The terminal reader and the contactless device establish a communication channel and the terminal reader transmits details of the merchant's loyalty rewards program with a request for user information. The user may accept the terms and rules of the merchant's loyalty program by interacting with the contactless device or the terminal reader. Alternatively, the user may accept the terms and rules of the merchant's loyalty program by tapping the contactless device in the terminal reader's radio frequency field. The contactless device reads the request for user information received from the terminal reader and accesses the user's information resident on the contactless device in an application, the user's contacts, a digital wallet application, the data storage unit or other area resident on the contactless device capable of storing the information. The contactless device may obtain the user information from more than one area, or the user may be prompted to input the user information. The user information may be entered or designated on the contactless device at any time prior to and during the tap.

In an alternative exemplary embodiment, the user information may be stored in a remote system. The remote system may be a third party system that operates separately or independently from the contactless device. The remote system comprises a user profile or account that stores the user information, for example a Google+ profile or a Google account. The user information may be entered into and saved by the remote system at any time prior to the tap. The remote system may transmit a unique user identification number to the contactless device. When the contactless device is tapped, the user's identification number is transmitted to the terminal reader. The merchant system may transmit the user's identification number to the remote system to retrieve the user's information. In an alternative exemplary embodiment, the merchant system transmits the user's identification number with a request to create a new loyalty account to the remote system.

The user may also set access controls to define sets of information the user authorizes for transmission to the terminal reader when registering for the merchant loyalty program. The contactless device may review the access controls to determine whether the information requested by the terminal reader is authorized by the user to be transmitted. The merchant may designate different levels of user information in the request. For example, the merchant may designate some information as “required” and thus must be transmitted by the contactless device in order to register the user. Other information may be designated as “requested.” Requested information may comprise information that the merchant asks for, but is not required to be transmitted in order to register the user. The contactless device may compare the required information to the access controls defined by the user. If the user has authorized the transmission of the required information, the contactless device transmits this information to the terminal reader. If the user has not authorized the transmission of the required information, the user may be prompted to override the access controls and authorize the transmission of the information.

The terminal reader receives the user information from the contactless device and forwards it to the merchant system. The new loyalty program account may be created by the merchant system or a remote system. A remote system may be a third party system that operates separately or independently from the merchant system. The merchant may designate a remote system to process, create and manage its loyalty program accounts. If the merchant has designated a remote system, the user information is forwarded from the merchant system to the remote system with a request to create a new merchant loyalty account. The remote system reads the user information and creates a new loyalty account before saving the new account information and forwarding an acknowledgement to the merchant system. If the merchant system processes and creates new loyalty program accounts, the merchant system may read the user information and create a new loyalty program account. In both embodiments, the merchant system may save the new loyalty account information before forwarding an acknowledgement to the contactless device. The acknowledgement may comprise the user's loyalty account number and this number may be saved in the contactless device for future use.

The functionality of the exemplary embodiments will be explained in more detail in the following description, read in conjunction with the figures illustrating the program flow.

### System Architecture

Turning now to the drawings, in which like numerals indicate like (but not necessarily identical) elements throughout the figures and exemplary embodiments are described in detail.

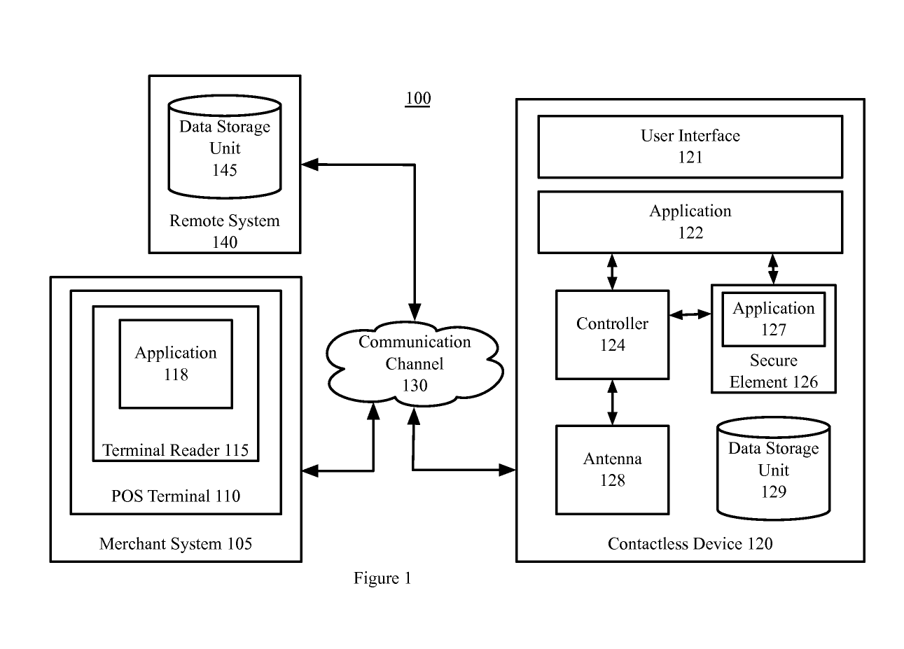

FIG. 1 is a block diagram depicting a system 100 for a one-tap sign up for merchant loyalty programs according to an exemplary embodiment. As depicted in FIG. 1, the exemplary operating environment 100 includes a merchant system 105, a contactless device system 120 and a remote system 140 that are configured to communicate with one another via one or more communication channels 130.

The communication channel 130 includes a telecommunication means by which network devices (including devices 110 and 120) can exchange data. In exemplary embodiments, the communication channel comprises a proximity communication connection, such as NFC or Bluetooth. Bluetooth can enable the exchange of data over short distances through the creation of PANs with high levels of security. Wi-Fi is yet another proximity communication type wherein contactless devices can communicate via a wireless ad hoc network.

In an exemplary embodiment, NFC communication protocols include, but are not limited to ISO/IEC 14443 type A and/or B technology (hereafter “ISO 14443”), MIFARE technology (hereafter “MIFARE”), and/or ISO/IEC 18092 technology (hereafter “ISO 18092”). ISO 14443 is a communication protocol for contactless devices operating in close proximity with a reader. An ISO 14443 communication protocol is utilized for secure card payments, including but not limited to credit card payments, debit card payments, and other forms of financial card payments. MIFARE is a communication protocol for contactless devices that comply with proprietary device standards that are based on ISO 14443. A MIFARE protocol is utilized for stored function transactions, including but not limited to gift cards, transit cards, tickets, access cards, loyalty cards, and other forms of stored value card transactions. A MIFARE protocol may also be used for limited value-added services. ISO 18092 is a communication protocol for contactless devices operating at higher bit rates, allowing for richer communication between the devices. An ISO 18092 communication protocol is utilized for peer-to-peer communication, value-added services (including, but not limited to, coupons, loyalty cards, check-ins, membership cards, gift cards, and other forms of value-added services), and other forms of richer communication. Any suitable NFC communication protocol can be used for NFC communication between the contactless device 120 and the terminal reader 115 to implement the methods and functionality described herein.

The merchant system 105 includes a terminal reader 115 that is capable of communicating with the contactless device system 120 and the merchant POS terminal 110 via an application 118. In an exemplary embodiment the terminal reader 115 communicates with the contactless device 120 using an NFC communication method. In another exemplary embodiment, the terminal reader 115 communicates with the contactless device 120 using a Bluetooth communication method. In yet another embodiment, the terminal reader 115 communicates with the contactless device 120 using a Wi-Fi communication method. While the terminal reader 115 is depicted as an integrated part of the POS terminal 110, the terminal reader 115 may also be a standalone hardware device, in accordance with alternative exemplary embodiments.

In an exemplary embodiment, the contactless device system 120 can refer to a smart device that can communicate via an electronic, magnetic, or radio frequency field between the device 120 and another device, such as a terminal reader 115. In an exemplary embodiment, the contactless device 120 has processing capabilities, such as storage capacity/memory and one or more applications 122 that can perform a particular function. In an exemplary embodiment, the contactless device 120 contains an operating system (not illustrated) and user interface 121. Exemplary contactless devices 120 include smart phones; mobile phones; personal digital assistants (PDAs); mobile computing devices, such as netbooks, tablets, and iPads; laptops; and other devices, in each case having processing and user interface functionality.

The contactless device 120 also comprises a secure element 126, which can exist within a removable smart chip or a secure digital (SD) card or which can be embedded within a fixed chip on the device 120. In certain exemplary embodiments, Subscriber Identity Module (“SIM”) cards may be capable of hosting a secure element 126, for example, an NFC SIM Card. The secure element 126 allows a software application 122 resident on the device 120 and accessible by the device user to interact securely with certain functions within the secure element 126, while protecting information stored within the secure element. The secure element 126 comprises applications 127 running thereon that perform the functionality described herein.

The secure element 126 includes components typical of a smart card, such as crypto processors and random generators. In an exemplary embodiment, the secure element 126 comprises a Smart MX type NFC controller 124 in a highly secure system on a chip controlled by a smart card operating system, such as a JavaCard Open Platform (“JCOP”) operating system. In another exemplary embodiment, the secure element 126 is configured to include a non-EMV type contactless smart card, as an optional implementation.

The secure element 126 communicates with the controller 124 and the application 122 in the contactless device 120. In an exemplary embodiment, the secure element 126 is capable of storing encrypted user information and only allowing trusted applications to access the stored information. The controller 124 interacts with a secure key encrypted application 122 for decryption and installation in the secure element 126.

In an exemplary embodiment, the controller 124 is an NFC controller. In an alternative exemplary embodiment, the controller 124 is a Bluetooth link controller. The Bluetooth link controller may be capable of sending and receiving data, identifying the smart card 110, performing authentication and ciphering functions, and directing how the contactless device 120 will listen for transmissions from the terminal reader 115 or configure the contactless device 120 into various power-save modes according to the Bluetooth-specified procedures. In another exemplary embodiment, the controller 124 is a Wi-Fi controller or an NFC controller capable of performing similar functions.

The application 122 is a program, function, routine, applet or similar entity that exists on and performs its operations on a contactless device 120. For example, the application 122 may be one or more of a digital wallet application, a loyalty card application, another value-added application, a user interface application, or other suitable application operating on the contactless device 120. Additionally, the secure element 126 also may comprise secure contactless software applications, such as payment applications, secure forms of the applications 122, authentication applications, payment provisioning applications, or other suitable application using the secure functionality of the secure element 126.

In an exemplary embodiment, the data storage unit 129 and application 122 may be implemented in the secure element 126, as described previously, on the contactless device 120. In an alternative exemplary embodiment, the data storage unit 129, may be a separate memory unit resident on the contactless device 120. An exemplary data storage unit 129 enables storage of user contact details for registration in a merchant loyalty program.

The contactless device 120 communicates with the terminal reader 115 via an antenna 128. In an exemplary embodiment, once the contactless device application 122 has been activated and prioritized, the controller 124 is notified of the state of readiness of the contactless device 120 for a transaction. The controller 124 outputs through the antenna 128 a radio signal, or listens for radio signals from the device reader 115. On establishing a secure communication channel between the contactless device 120 and the device reader 115, the device reader 115 requests the list of available applications 127 from the secure element 126. A directory is first displayed, after which, based on the set priority or the type of device reader 115, an application 127 is chosen and initiated for the transaction.

The exemplary remote system 140 enables storage of merchant loyalty program information. In an exemplary embodiment, the merchant (not illustrated) creates a loyalty program account with the remote system 140. The remote system stores the loyalty program data, including the registration information received from users and corresponding user loyalty account numbers in the data storage unit 145.

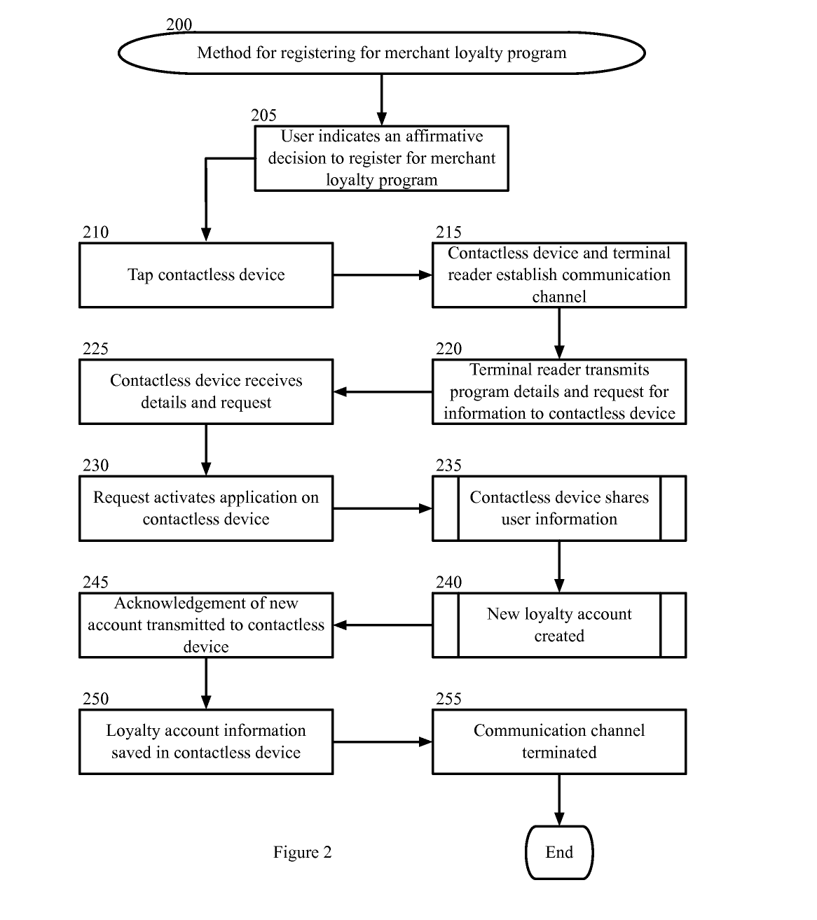

The components illustrated in FIG. 1 will be described in further detail hereinafter with reference to the methods depicted in FIGS. 2-6.

### System Process

FIG. 2 is a block flow diagram depicting a method for registering for merchant loyalty programs according to an exemplary embodiment. The method 200 is described with reference to the components illustrated in FIG. 1.

In block 205, a user (not illustrated) indicates an affirmative decision to register for a merchant reward program. In an exemplary embodiment, a terminal reader 115 presents a message to the user regarding the merchant's loyalty reward program. In an exemplary embodiment, the user may press a button on the terminal reader 115 to sign up for the loyalty reward program. In an alternative exemplary embodiment, the user may tap the contactless device 120 to indicate an affirmative decision to register for the loyalty program.

In an alternative exemplary embodiment, the merchant may ask the user to sign up for the loyalty program. In an exemplary embodiment, the user may respond by verbally answering and the merchant may press a button or set of keystrokes to indicate an affirmative decision. In an alternative exemplary embodiment, the user may indicate an affirmative decision by pressing a button on the terminal reader 115 or tapping the contactless device 120.

In block 210, the user taps the contactless device 120 in the proximity of the terminal reader 115. In an exemplary embodiment, the terminal reader 115 generates a radio frequency (RF) or other field polling for the presence of a contactless device 120, and the user “taps” the contactless device 120 by placing the device 120 within the field of the terminal reader 115. In an alternative exemplary embodiment, the merchant activates the RF field or other field to poll for the presence of a contactless device 120 using an application 118 on the terminal reader 115. In certain exemplary embodiments, the systems and methods described in FIGS. 2-6 herein are performed while the contactless device 120 is tapped.

In an exemplary embodiment, the methods described in FIGS. 2-6 may be automated, requiring no input by a user after a contactless device 120 is tapped with a terminal reader 115. In this embodiment, the steps requesting user input, as described in blocks 320, 450, 455, 465, and 510-540 may not be required.

In an exemplary embodiment, the tap may occur during a payment transaction. In an alternative exemplary embodiment, the tap may occur separately from the payment transaction, for example, prior to the beginning of a new transaction or after the completion of the payment transaction.

In block 215, the contactless device 120 and the terminal reader 115 establish a communication channel 130. In an exemplary embodiment, the communication channel 130 is an NFC communication channel. In an alternative exemplary embodiment, the communication channel 130 is a Bluetooth communication channel. In yet another exemplary embodiment, the communication channel 130 is a Wi-Fi communication channel.

In an exemplary embodiment, the terminal reader 115 requests protocols and characteristics from the contactless device 120 to establish the communication channel 130. For example, the terminal reader 115 may request the identification of communication protocols (for instance ISO/IEC 14443, MIFARE, and/or ISO/IEC 18092), a list of applications 122 available, and security protocols from the contactless device 120. card 110 for mutual authentication between the smart card 110 and the contactless device 120.

In block 220, the terminal reader 115 transmits details of the merchant's loyalty program and a request for user information to the contactless device 120. In an exemplary embodiment, the request for user information comprises a list of data required to register for the merchant loyalty program. For example, the user's name, address, phone number, and e-mail address. In an alternative exemplary embodiment, the request for user information also comprises a list of data requested, but not required to register for the merchant loyalty program. For example, the user's birthday, age and gender. In an exemplary embodiment, the details of the merchant's loyalty program comprise the program's terms of use and program rules.

In block 225, the contactless device 120 receives the details of the merchant's loyalty program and the request for user information from the terminal reader 115.

In block 230, an application 122 is activated on the contactless device 120. In an exemplary embodiment, receipt of the details of the merchant's loyalty program and the request for user information from the terminal reader 115 automatically activates an application 122 on the contactless device 120. In an alternative exemplary embodiment, the user activates an application 122 on the contactless device 120 before or after receiving the details of the merchant's loyalty program and the request for user information from the terminal reader 115.

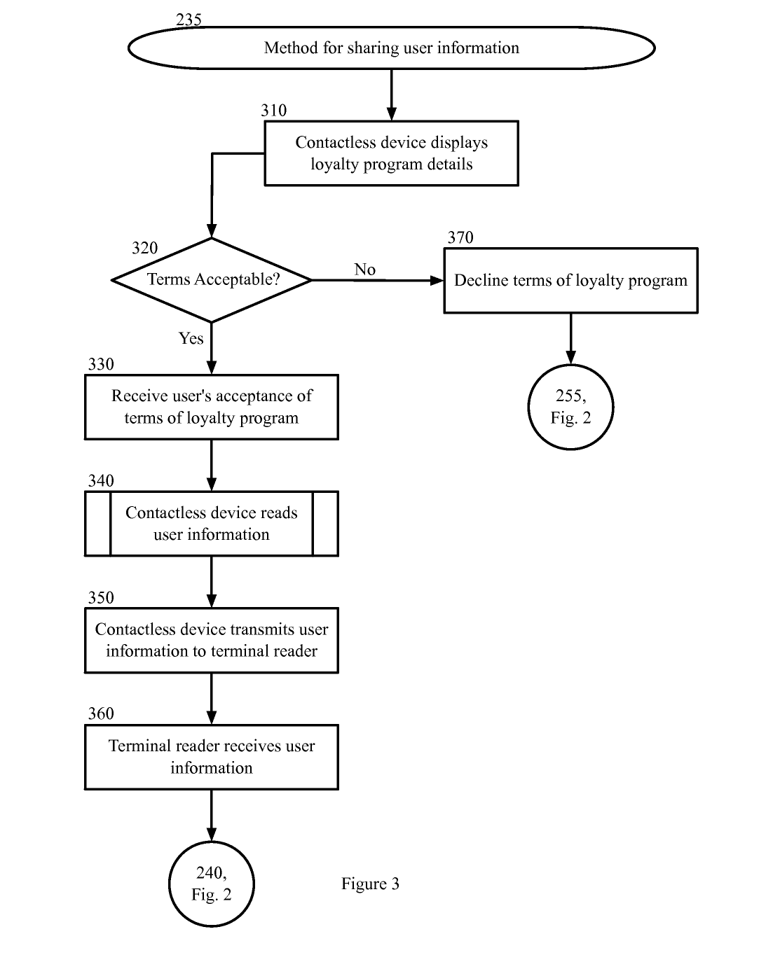

In block 235, the contactless device 120 transmits the user information to the terminal reader 115. The method for sharing user information is described in more detail hereinafter with reference to the methods described in FIG. 3.

FIG. 3 is a block flow diagram depicting a method for sharing user information according to an exemplary embodiment, as referenced in block 235 in FIG. 2. The method 235 is described with reference to the components illustrated in FIG. 1.

In block 310, the contactless device 120 displays the loyalty program details. In an exemplary embodiment, the details are displayed by the application 122 for review by the user on the contactless device 120. In an alternative exemplary embodiment, the loyalty program details are displayed at the terminal reader 115 for review by the user. In this embodiment, the loyalty program details may be displayed prior to the user tapping the contactless device 120 and the user may tap the contactless device 120 to indicate an agreement with the terms and rules contained with the details of the merchant loyalty program. In this embodiment, the steps following the tap of the contactless device 120 may be automatic, wherein the user is automatically signed up for the loyalty program after the tap.

In block 320, the user indicates whether the terms of the merchant's loyalty program are acceptable. In an exemplary embodiment, the user presses a button on the contactless device 120 using the user interface 121 to indicate whether the terms of the merchant's loyalty program are acceptable. In an alternative exemplary embodiment, the user indicates whether the terms of the merchant's loyalty program are acceptable by pressing a button on the terminal reader 115. In yet another alternative exemplary embodiment, the user may tap the contactless device 120, as described above, to indicate whether the terms of the merchant's loyalty program are acceptable. In this embodiment, the terminal reader 115 may display the terms of the merchant's loyalty program before the user taps the contactless device 120 in block 210. For example, the terms of the merchant's loyalty program may be displayed by the terminal reader 115 in block 205 before the user indicates an affirmative decision to register for the program. In an alternative exemplary embodiment, the user's registration in the merchant's loyalty program is acceptance of the programs terms of user and rules. In this embodiment, the steps described in blocks 310-330 and 370 are not performed. Instead, the method 235 proceeds automatically, without user input after the contactless device 120 is tapped.

If the user indicates that the terms of the merchant's loyalty program are not accepted, the method 235 proceeds to block 370.

In block 370, the contactless device 120 or terminal reader 115 receives the user's declination of the terms. In an exemplary embodiment, the contactless device 120 receives the declination of the terms and transmits the user's response to the terminal reader 115. The method 235 then proceeds to block 255 in FIG. 2.

If the user indicates that the terms of the merchant's loyalty program are acceptable, the method 235 proceeds to block 330.

In block 330, the contactless device 120 or terminal reader 115 receives the user's acceptance of the terms of the merchant's loyalty program. In an exemplary embodiment, the contactless device 120 receives the acceptance of the terms and transmits the user's response to the terminal reader 115. In an alternative exemplary embodiment, the contactless device 120 receives the acceptance of the terms without transmitting the user's response to the terminal reader 115.

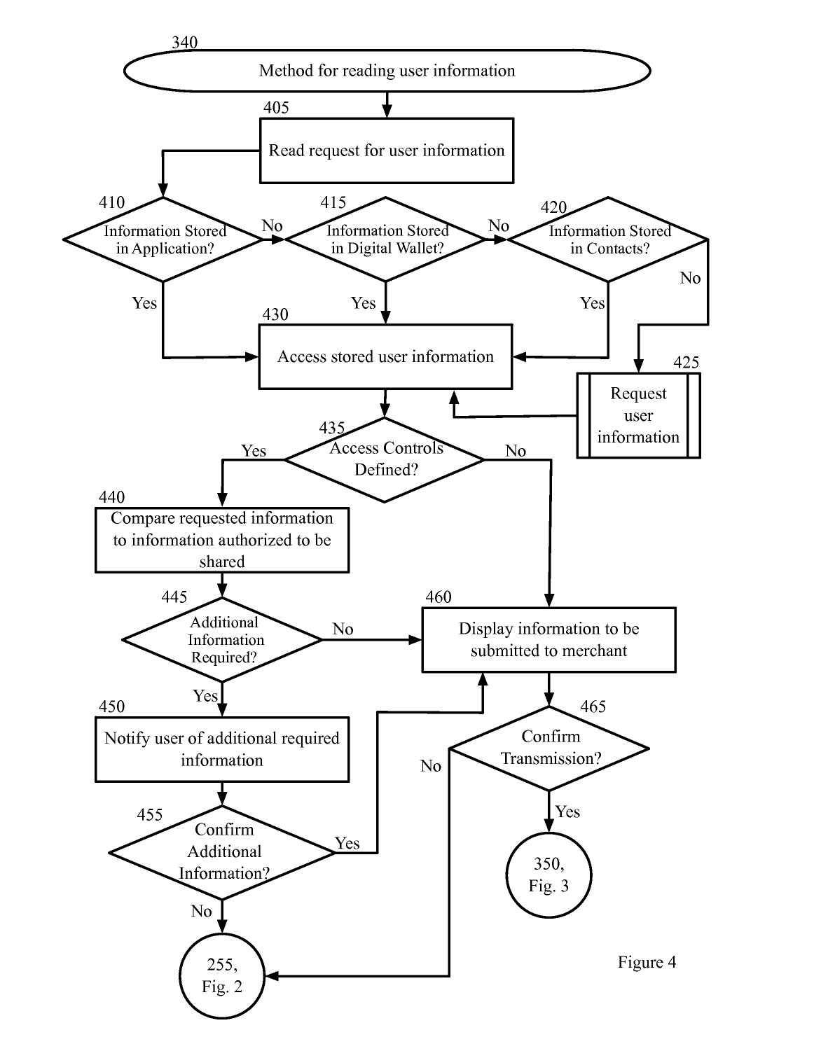

In block 340, the contactless device 120 reads the user information requested by the terminal reader 115. The method for reading user information is described in more detail hereinafter with reference to the methods described in FIG. 4.

FIG. 4 is a block flow diagram depicting a method for reading user information according to an exemplary embodiment, as referenced in block 340 in FIG. 3. The method 340 is described with reference to the components illustrated in FIG. 1.

In block 405, the contactless device 120 reads the request for user information received from the terminal reader 115 in block 225. In an exemplary embodiment, the contactless device 120 automatically reads the request for user information when the application 122 is activated. In an alternative exemplary embodiment, the contactless device 120 reads the request for user information after the user indicates an acceptance of the terms of the merchant loyalty program.

The contactless device 120 retrieves the user information read in the request from the terminal reader 115. In an exemplary embodiment, blocks 410-420 may be performed in any order. In an exemplary embodiment, the contactless device 120 may retrieve pieces of user information from more than method as described in blocks 410-420.

In block 410, the contactless device 120 retrieves the user information stored in the application 122 resident on the contactless device 120. In an exemplary embodiment, the user may complete fields of user information when the application is downloaded onto the contactless device 120 at some time prior to the methods described herein. For example, the user may download an application 122 designed to aid in the one-tap sign up for merchant loyalty programs. When the user accesses the application 122 for the first time, the user may be prompted to complete common user details required for registering for various merchant reward programs, such as the user's name, address, phone number, e-mail address, age, birthday, gender, or other common user details. The user may access the program 122 and add additional information, modify existing information or delete information at any time. In an alternative exemplary embodiment, the application 122 may prompt the user to use an existing contact saved in the data storage unit 129 to populate the user data in the application 122. In yet another alternative exemplary embodiment, the application 122 may prompt the user to associate the application 122 with a digital wallet application resident on the contactless device 120.

In an alternative exemplary embodiment, the user information may be stored in the remote system 140. The remote system 140 comprises a user profile or account that stores the user information, for example a Google+ profile or a Google account. The remote system 140 may transmit a unique user identification number to the contactless device 120. When the contactless device 120 is tapped, the user's identification number is transmitted to the terminal reader 115.

If the contactless device 120 retrieves all the user information requested by the terminal reader 120 from the information stored in the application 122 resident on the contactless device 120, the method proceeds to block 430.

If the contactless device 120 does not retrieve all the user information requested by the terminal reader 120 from the information stored in the application 122 resident on the contactless device 120, the method proceeds to block 415.

In block 415, the contactless device retrieves the user information stored in a digital wallet application 127 resident on the contactless device. In an exemplary embodiment, the user may register a digital wallet application 127 at some time prior to the methods described herein. For example, the user may have a digital wallet application 127 used to complete financial payments via an NFC wireless tap. The user may enter user information into the digital wallet application, such as name, address, phone number, e-mail address, birthday, age, gender or other user details. In an exemplary embodiment, these details may be entered in connection with a financial card previously registered with the digital wallet application 127. In an alternative exemplary embodiment, these details may be general details saved within the digital wallet application 127 and associated with the user's account.

If the contactless device 120 retrieves all the user information requested by the terminal reader 120 from the information stored in the digital wallet application 127 resident on the contactless device 120, the method proceeds to block 430.

If the contactless device 120 does not retrieve all the user information requested by the terminal reader 120 from the information stored in the digital wallet application 127 resident on the contactless device 120, the method proceeds to block 420.

In block 420, the contactless device 120 retrieves the user information stored in the contacts resident on contactless device 120. In an exemplary embodiment, the user may designate a contact as containing the user's information. In an alternative exemplary embodiment, the contactless device 120 retrieves the user information store in the data storage unit 129 resident on the contactless device 120.

If the contactless device 120 retrieves all the user information requested by the terminal reader 120 from the information stored in the contacts resident on the contactless device 120, the method proceeds to block 430.

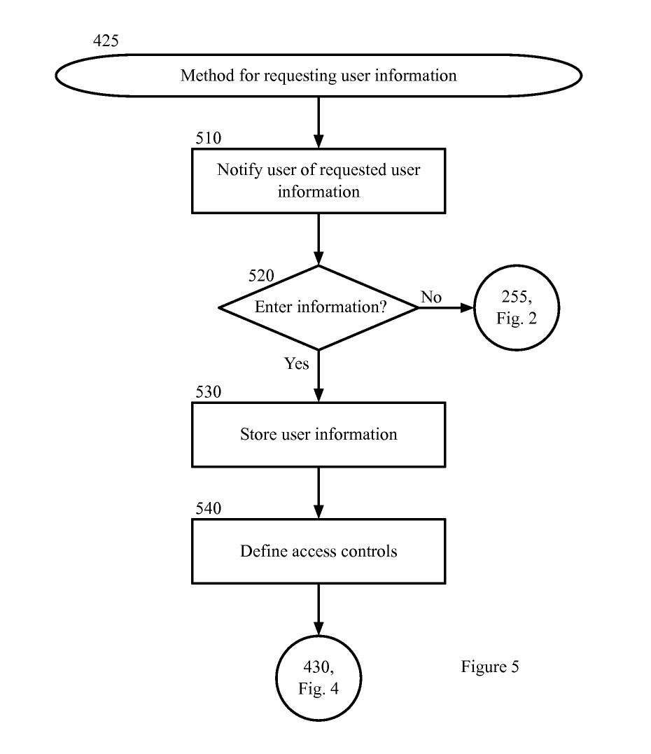

If the contactless device 120 does not retrieve all the user information requested by the terminal reader 120 from the information stored in the contacts resident on the contactless device 120, the method proceeds to block 425. The method for requesting user information is described in more detail hereinafter with reference to the methods described in FIG. 5.

FIG. 5 is a block flow diagram depicting a method for requesting user information according to an exemplary embodiment, as referenced in block 425 in FIG. 4. The method 425 is described with reference to the components illustrated in FIG. 1.

In block 510, the contactless device 120 notifies the user of the requested user information not available in the application 122, digital wallet application 127, contacts or data storage unit 129 resident on the contactless device 120. In an exemplary embodiment, the contactless device 120 automatically checks one or more of the application 122, digital wallet application 127, contacts or data storage unit 129 resident on the contactless device 120 before notifying the user of the requested information. The contactless device 120 may retrieve part of the information from one or more of the application 122, digital wallet application 127, contacts or data storage unit 129 resident on the contactless device 120, but may still require additional information to fulfill the required or requested user information.

In an exemplary embodiment, the contactless device 120 may prompt the user of the additional requested information using the application 122. In an alternative exemplary embodiment, the contactless device 120 may prompt the user using a pop-up window on the user interface 121 of the contactless device 120. In yet another alternative exemplary embodiment, the methods described herein may be automated and the contactless device may not notify the user of the additional requested information. In this embodiment, if the contactless device 120 cannot retrieve the user information required to register for the merchant loyalty program, the contactless device 120 may notify the terminal reader 115 and the automated method may be terminated.

In block 520, the user is requested to enter the user information. In an exemplary embodiment, the user is requested to fill out data fields in the application 122. In an alternative exemplary embodiment, the user is requested to designate a contact or a digital wallet account 127 to supply the user information.

If the user declines to provide the requested user information the method 425 proceeds to block 255 in FIG. 2.

If the user provides the requested user information, the method 425 proceeds to block 530.

In block 530, the contactless device 120 stores the user information. In an exemplary embodiment, the contactless device 120 stores the user information in the applications 122. In an alternative exemplary embodiment, the contactless device 120 stores the user information in the digital wallet application 127. In yet another alternative exemplary embodiment, the contactless device 120 stores the user information in the contacts.

In block 540 the user may define access controls. In an exemplary embodiment, the access controls are rules defining which pieces of user information may be disclosed to the terminal reader 115. For example, the user may only wish to share a name and phone number when registering for a merchant loyalty program. In this example, the contactless device 120 would then only be authorized to share the name and phone number with the terminal reader in response to the request for user information. The user would be prompted to approve the transmission of additional details before the contactless device 120 would transmit such details. In an exemplary embodiment, the user may define levels of information. For example, the user may wish to only share a name and phone number if that information is sufficient to register for the merchant loyalty program. However, the user may designate that the user's e-mail address may also be provided if it is required, but not if it is only requested by the merchant. In this example, the merchant may designate certain user information as “required” and thus must be supplied by the contactless device 120 in order to register for the loyalty program. The merchant may also designate certain user information as “requested” and thus are asked for, but are not required by the contactless device 120 in order to register for the loyalty program. The requested user information may be transmitted at the same time as the required user information, but may be designated as only requested information. In an alternative exemplary embodiment, the user may designate certain information as requiring user approval before transmission to the terminal reader. For example, the user may share a name and phone number, but will only share an address with certain merchants. Therefore, the user requires the contactless device 120 to prompt the user to confirm that it is okay to transmit an address before transmitting it to the terminal reader 115.

The method 425 then proceeds to block 430 in FIG. 4.

Returning to FIG. 4, in block 430, contactless device 120 accesses the user information requested by the terminal reader 115 to register for the merchant loyalty program. In an exemplary embodiment, the user information was read from the application 122, digital wallet application 127, contacts or data storage unit 129 in blocks 410-420. In an alternative exemplary embodiment, the user information was entered by the user in block 425.

In block 435, the contactless device 120 reviews the access controls defined by the user. In an exemplary embodiment, the access controls are defined by the user when the information is entered in the application 122 or when the user accesses the application 122 prior to the methods described herein. In an alternative exemplary embodiment, the user has not defined access controls and the method proceeds to block 460. In yet another alternative exemplary embodiment, the methods described herein are automated and are performed without user interaction. In this embodiment, the method proceeds to block 350 in FIG. 3.

In block 440, the contactless device 120 compares the requested or required user information accessed in block 430 to information designated by the user as authorized to be shared by the access controls. In an exemplary embodiment, the contactless device 120 reviews the user information and determines whether any of the information has limitations or restrictions on transmission to the terminal reader 115.

In block 445, the contactless device determine if additional information is required to register for the merchant loyalty program.

If additional information is not required, the method proceeds to block 460.

If additional information is required, the method proceeds to block 450.

In block 450, the contactless device 120 notifies the user of the additional information required to register for the merchant loyalty program. In an exemplary embodiment, the additional information is presented in the application 122. In an alterative exemplary embodiment, the additional information is presented in a pop-up window on the user interface 121 of the contactless device 120.

In block 455, the user is prompted to confirm the sharing of the additional required information to the terminal reader 115 to register for the merchant loyalty program.

If the user declines to share the additional required information the method proceeds to block 255 in FIG. 2.

If the user accepts the sharing of the additional required information the method proceeds to block 460.

In block 460, the contactless device 120 displays the user information to be submitted to the terminal reader 115. In an exemplary embodiment, the user information is displayed in a list format using the application 122. In an alternative exemplary embodiment, the user information is displayed in a pop-up window on the user interface 121 of the contactless device 120.

If the user declines to transmit the user information to the terminal reader 115, the method proceeds to block 255 in FIG. 2.

If the user accepts to transmit the user information to the terminal reader 115, the method proceeds to block 465.

In block 465, the user confirms the transmission of the user information to the terminal reader 115. In an exemplary embodiment, the user presses a button on the user interface 121 to confirm the transmission. In an alternative exemplary embodiment, the process is automated and the user information is automatically transmitted to the terminal reader 115 when the contactless device 120 is tapped.

The method 340 proceeds to block 350 in FIG. 3.

Returning to FIG. 3, in block 350, the contactless device 120 transmits the user information to the terminal reader 115. In an exemplary embodiment, the user information is transmitted through the communication channel 130 established in block 215 (FIG. 2).

In an alternative exemplary embodiment, the contactless device 120 transmits the user's remote system identification number to the terminal reader 115.

In block 360, the terminal reader 115 receives the user information transmitted by the contactless device 120.

The method 235 then proceeds to block 240 in FIG. 2.

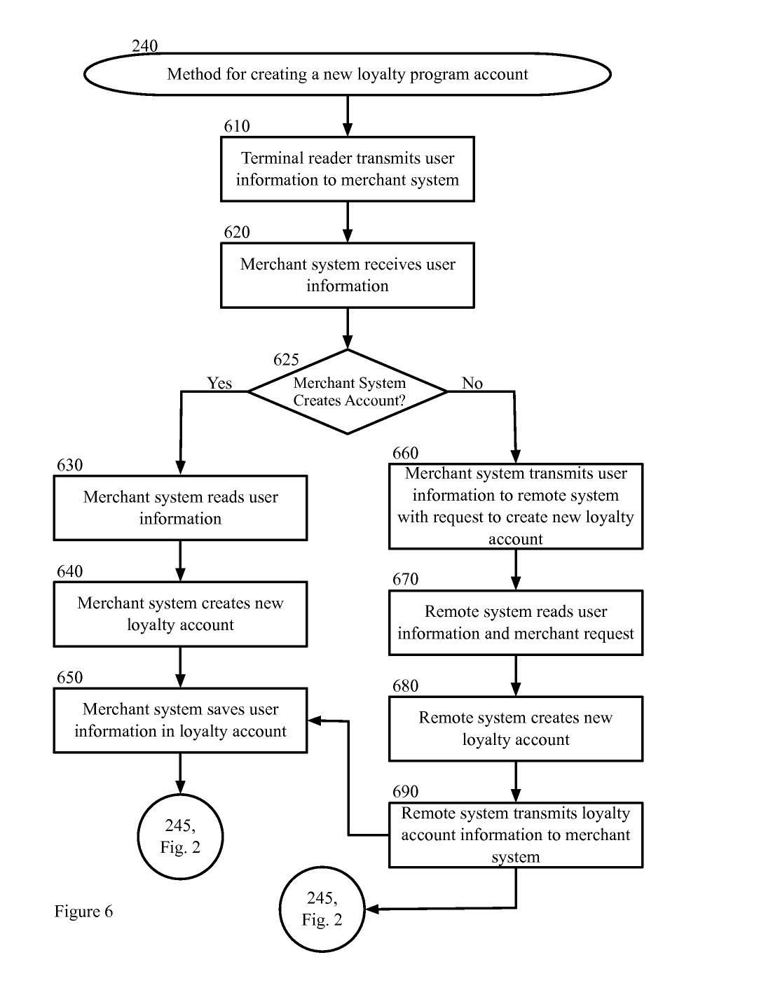

Returning to FIG. 2, in block 240, a new merchant loyalty account is created. The method of creating a new merchant loyalty account is in more detail hereinafter with reference to the methods described in FIG. 6.

FIG. 6 is a block flow diagram depicting a method for creating a new loyalty program account according to an exemplary embodiment, as referenced in block 240 in FIG. 2. The method 240 is described with reference to the components illustrated in FIG. 1.

In block 610, the terminal reader 115 transmits the user information to the merchant system 105. In an exemplary embodiment, the user information is used by the merchant system to create a new loyalty account for the user. In an alternative exemplary embodiment, the user information is used by the terminal reader 115 to create a new loyalty account for the user. In this embodiment, the blocks 610 and 620 may be skipped. In yet another alternative exemplary embodiment, the user information is used by a third party system, such as the remote system 140, to create a new loyalty account for the user.

In block 620, the merchant system 105 receives the user information from the terminal reader 115.

In block 625, the merchant system 105 determines whether it will create the new loyalty account. In an exemplary embodiment, the merchant will have a third party system, such as the remote system 140, create and manage loyalty accounts. In an alternative exemplary embodiment, the merchant system 105 will create and manage loyalty accounts.

If the merchant system 105 will create the new loyalty account, the method proceeds to block 630.

In block 630, the merchant system 105 reads the user information. In an exemplary embodiment, the user information is read by an application 118 resident in the merchant system. For example, the application may be resident on the terminal reader 115, POS terminal 110, or other part of the merchant system 105 not illustrated.

In an alternative exemplary embodiment, the merchant system 105 may transmit the user's identification number to the remote system 140 to retrieve the user's information.

In block 640, the merchant system 105 creates a new loyalty account for the user. In an exemplary embodiment, the merchant system confirms that the required user information was transmitted by the contactless device 120. In an exemplary embodiment, the merchant system 105 assigns a new loyalty account number to the new loyalty account corresponding to the user information.

In block 650, the merchant system 105 saves the user information in the new loyalty account. In an exemplary embodiment, the user information may be used to look up and identify the loyalty account if the user cannot recall the loyalty account number.

The method 240 then proceeds to block 245 in FIG. 2.

If the merchant system 105 will not create the new loyalty account, the method 240 proceeds to block 660 in FIG. 6.

In block 660, the merchant system 105 transmits the user information and a request to create a new merchant loyalty account to the remote system 140. In an exemplary embodiment, the remote system 140 has a pre-established relationship with the merchant system 105, wherein the remote system 140 creates and manages loyalty account information for the merchant. In an alternative exemplary embodiment, the merchant system 105 transmits the user's identification number with a request to create a new loyalty account to the remote system 140.

In block 670, the remote system 140 receives and reads the user information and the request to create a new merchant loyalty account.

In block 680, the remote system 140 creates a new merchant loyalty account. In an exemplary embodiment, the remote system 140 saves the new merchant loyalty account information in the data storage unit 145. In an alternative exemplary embodiment, the remote system 140 does not save the new merchant loyalty account information and the method 240 proceeds directly to block 690.

In block 690, the remote system 140 transmits the loyalty account information to the merchant system 105.

The method 240 then proceeds to block 650 in FIG. 6.

As previously described, in block 650, the merchant system 105 saves the user information in the new loyalty account. The method 240 then proceeds to block 245 in FIG. 2.

If the merchant system 105 does not save the user information in the new loyalty account in block 650, the method 240 proceeds directly to block 245 in FIG. 2.

Returning to FIG. 2, in block 245, the merchant system 105 transmits an acknowledgement of the new loyalty account to the contactless device 120. In an exemplary embodiment, the merchant system 105 transmits the acknowledgement to the terminal reader 115 and the terminal reader 115 transmits the acknowledgement to the contactless device 120. In an alternative exemplary embodiment, the remote system 140 transmits an acknowledgement of the new merchant loyalty account to the contactless device 120. In an exemplary embodiment, the acknowledgement comprises a notice that the new loyalty account was created and the user's loyalty account number.

In block 250, the user's loyalty account information is saved in the contactless device 120. In an exemplary embodiment, the contactless device 120 receives the acknowledgement of the new loyalty account and saves the loyalty account number. In an exemplary embodiment, the loyalty account information is saved in the data storage unit 129 resident on the contactless device 120. In an alternative exemplary embodiment, the loyalty account information is saved in the application 122. In an exemplary embodiment, the application 122 is a digital wallet application. In yet another alternative exemplary embodiment, the loyalty account information is saved in the secure element 126.

In block 255 the communication channel 130 between the terminal reader 115 and the contactless device 120 is terminated. In an exemplary embodiment, the original communication channel 130 can be terminated when the request to terminate a communication channel 130 between the terminal reader 115 and the contactless device 120 is communicated, or any suitable time thereafter.

### General

Users may be allowed to limit or otherwise affect the operation of the features disclosed herein. For example, users may be given opportunities to opt-in or opt-out of the collection or use of certain data or the activation of certain features. In addition, users may be given the opportunity to change the manner in which the features are employed, including for situations in which users may have concerns regarding privacy. Instructions also may be provided to users to notify them regarding policies about the use of information, including personally identifiable information, and manners in which each user may affect such use of information. Thus, information can be used to benefit a user, if desired, through receipt of relevant advertisements, offers, or other information, without risking disclosure of personal information or the user's identity.

One or more aspects of the exemplary embodiments may include a computer program that embodies the functions described and illustrated herein, wherein the computer program is implemented in a computer system that comprises instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. Moreover, any reference to an act being performed by a computer should not be construed as being performed by a single computer as more than one computer may perform the act.

The exemplary systems, methods, and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described above in detail, the description is merely for purposes of illustration. Various modifications of, and equivalent blocks and components corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

1. A computer-implemented method to automatically process and register users for merchant loyalty reward programs by determining whether sets of required and optional user information details are permitted to be transmitted to merchants, comprising:
in response to placement of a mobile communication device in proximity to a point of sale system reader:
establishing a communication channel between the mobile communication device and the point of sale system reader;
receiving, by the mobile communication device from the point of sale system reader, a request for user information, the request for user information comprising a request for details about the user requested by a merchant to register the user in a merchant loyalty reward program, the request for details comprising a set of required details about the user and a set of optional details about the user;
retrieving, by the mobile communication device, the user information in response to receiving the request for user information;
determining, by the mobile communication device, which user information corresponds to the set of required details about the user and which user information corresponds to the set of optional details about the user;
reviewing, by the mobile communication device, a set of access controls, the set of access controls comprising one or more rules defining which user information may be transmitted by the mobile communication device in response to a request;
determining, by the mobile communication device, that the user information that corresponds to the set of required details about the user complies with the access controls defined by the user, in response to reviewing the set of access controls;
determining, by the mobile communication device, which sets of user information that corresponds to the set of optional details about the user comply with the access controls defined by the user, in response to reviewing the set of access controls;
transmitting, by the mobile communication device, to the point of sale system reader (1) the user information that corresponds to the set of required details about the user and (2) the sets of user information that correspond to the set of optional details and that comply with the access controls defined by the user, the mobile communication device not transmitting the sets of user information that corresponds to the set of optional details but that do not comply with the access controls defined by the user; and
receiving, by the mobile communication device, an acknowledgment of the creation of a new merchant loyalty reward account, the acknowledgement comprising a loyalty reward account number.

2. The computer-implemented method of claim 1, wherein the user information comprises one or more of the following the user's name, address, phone number, e-mail address, and birthday.

3. The computer-implemented method of claim 1, further comprising saving the loyalty reward account number by the mobile communication device.

4. The computer-implemented method of claim 1, wherein the user information is retrieved via a digital wallet application.

5. The computer-implemented method of claim 1, wherein the user information is retrieved via an application resident on the mobile communication device.

6. The computer-implemented method of claim 1, wherein the communication channel is established using one of a near field communication (NFC) protocol, a Bluetooth protocol, and a Wi-Fi protocol.

7. The computer-implemented method of claim 1, wherein the mobile communication device is a mobile telephone.

8. A computer program product, comprising:
a non-transitory computer-readable medium having computer-executable program code embodied therein to automatically process and register users for merchant loyalty reward programs, the computer-executable program code comprising:
computer-readable program code to, in response to placement of a mobile communication device in proximity to a point of sale system reader:
receive a request for user information, the request for user information comprising a request for details about the user requested by a merchant to register the user in the merchant loyalty reward program, the request for details comprising a set of required details about the user and a set of optional details about the user;
determine which user information corresponds to the set of required details about the user and which user information corresponds to the set of option details about the user;
review a set of access controls, the set of access controls comprising one or more rules defining which user information may be transmitted by the mobile communication device in response to a request;
determine that the user information that corresponds to the set of required details about the user complies with the access controls defined by the user, in response to reviewing the set of access controls;
determine which sets of user information that corresponds to the set of optional details about the user comply with the access controls defined by the user, in response to reviewing the set of access controls;
transmit (1) the user information that corresponds to the set of required details about the user and (2) the sets of user information that correspond to the set of optional details and that comply with the access controls defined by the user to the point of sale system reader, the mobile communication device not transmitting the sets of user information that corresponds to the set of optional details but that do not comply with the access controls defined by the user; and
receive an acknowledgment of creation of a new merchant loyalty reward account, the acknowledgement comprising a loyalty reward account number.

9. The computer program product of claim 8, further comprising computer-readable program code for establishing a communication channel between the mobile communication device and the point of sale reader.

10. (canceled)

11. The computer program product of claim 8, wherein user information comprises one or more of the following the user's name, address, phone number, e-mail address, and birthday.

12. The computer program product of claim 8, further comprising computer-readable program code for saving the loyalty reward account number by the mobile communication device.

13. The computer program product of claim 9, further comprising computer-readable program code for terminating the communication channel between the mobile communication device and the point of sale reader.

14. The computer program product of claim 8, wherein the user information is retrieved via a digital wallet application.

15. The computer program product of claim 8, wherein the user information is retrieved via an application resident on the mobile communication device.

16. A system to automatically register users for merchant loyalty reward programs, comprising:
a storage device; and
a processor communicatively coupled to the storage device, wherein the processor executes application code instructions that are stored in the storage device, in response to placement of a mobile communication device in proximity to a point of sale system reader, to cause the system to:
receive a request for user information, the request for user information comprising a request for details about the user requested by a merchant to register the user in a merchant loyalty reward program, the request for details comprising a set of required details about the user and a set of optional details about the user;
determine which user information corresponds to the set of required details about the user and which user information corresponds to the set of option details about the user;
review a set of access controls, the set of access controls comprising one or more rules defining which user information may be transmitted by the mobile communication device in response to a request;
determine that the user information that corresponds to the set of required details about the user complies with the access controls defined by the user, in response to reviewing the set of access controls;
determine which sets of user information that corresponds to the set of optional details about the user comply with the access controls defined by the user, in response to reviewing the set of access controls;
transmit (1) the user information that corresponds to the set of required details about the user and (2) the sets of user information that correspond to the set of optional details and that comply with the access controls defined by the user to the point of sale system reader, the mobile communication device not transmitting the sets of user information that corresponds to the set of optional details but that do not comply with the access controls defined by the user; and
receive an acknowledgment of the creation of a new merchant loyalty reward account, the acknowledgement comprising a loyalty reward account number.

17. (canceled)

18. The system of claim 16, wherein the processor is further configured to execute computer-executable instructions stored in the storage device to cause the system to save the loyalty reward account number by the mobile communication device.

19. The system of claim 16, wherein the processor is further configured to execute computer-executable instructions stored in the storage device to cause the system to terminate the communication channel between the mobile communication device and the point of sale reader.

20. The system of claim 16, wherein the user information comprises one or more of the following the user's name, address, phone number, e-mail address, and birthday.

21. The system of claim 16, wherein the wherein the user information is retrieved via a digital wallet application.

22. The system of claim 16, wherein the user information is retrieved via an application resident on the mobile communication device.
